(19) United States
(12) Patent Application Publication
(10) Pub. No.: US 2025/0196442 A1
(43) Pub. Date: Jun. 19, 2025

(54) Method for manufacturing a two- or three-dimensional part having a composite architecture with at least two different micro-lattices connected to each other

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(72) Inventors: Antoine MONTIEL, Gif-sur-Yvette Cedex (FR); Daniel BONAMY, Gif-sur-Yvette Cedex (FR); Thibaud DERIEUX, Gif-sur-Yvette Cedex (FR); Laura SCHITTECATTE, Gif-sur-Yvette Cedex (FR); Valérie GEERTSEN, Gif-sur-Yvette Cedex (FR); Patrick GUENOUN, Gif-sur-Yvette Cedex (FR); Thuy NGUYEN, Bourg la Reine (FR)

(73) Assignees: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR)

(21) Appl. No.: 18/980,137

(22) Filed: Dec. 13, 2024

(30) Foreign Application Priority Data
Dec. 14, 2023 (FR) 2314151

(51) Int. Cl. B29C 64/386; B33Y 50/00; B33Y 80/00; G06F 30/12

(52) U.S. Cl. CPC B29C 64/386; B33Y 50/00; B33Y 80/00; G06F 30/12

(57) ABSTRACT

The invention relates to a method of manufacturing a two- or three-dimensional part having a composite architecture with at least two different micro-lattices connected to each other, comprising the following steps:
performing (100) a computer-implemented design step comprising the following steps:
   A) defining (100A) a domain representing said part to be manufactured, then defining a first sub-domain for a first micro-lattice and a second sub-domain, complementary to the first sub-domain, to delimit a second micro-lattice different from the first micro-lattice;
   B) defining (100B), over the whole domain, the coordinates of the generating centres for the two micro-lattices,
   C) defining (100C) the first micro-lattice
   D) defining (100D) the second micro-lattice
   E) connecting (100E) the second micro-lattice to the first micro-lattice.
   the design step also defining a shape and associated transverse dimensions for each micro-beam, and then:
manufacturing (200) the architecture designed in this way.

### TECHNICAL FIELD OF THE INVENTION

The invention relates to the field of materials with a composite architecture.

### TECHNICAL BACKGROUND

A composite material is generally obtained by assembling two (or more) individual materials with different mechanical properties.

The existing solutions are generally based on the use of different individual materials. A composite material can then provide more advantageous mechanical behaviours than the individual constituent materials alone. Generally speaking, the mechanical behaviour of a material is defined by its Young's modulus (E) and Poisson's modulus (v) to characterise stiffness, its yield strength (σ_{Y}) to characterise hardness, and its toughness (K_{C}) to characterise fracture resistance. For these quantities to be material constants, the microstructure of each of the constituent materials must be isotropic.

The composite materials include, for example, reinforced concrete (composite with concrete to provide compressive strength and steel reinforcement to provide tensile strength), the glass fibres embedded in a resin (glass fibre assembly to ensure stiffness and resin, for example a thermoplastic resin such as polyester to ensure fracture resistance) or, taking into account an example from the natural environment, the mother of pearl whose brick and mortar structure, composed of a hard mineral phase (brick) and a soft organic phase (mortar) confers a combination of properties of hardness and toughness unmatched. More general reference can be made to Clyne, D. Hull, An introduction to composite materials, 3rd edition, Cambridge University Press (2019).

In addition to the choice of the individual constituent materials of the composite material, the spatial organisation of the various individual constituent materials is a key element in optimising the mechanical properties. For example, in the case of mother-of-pearl, the fact that the mineral (hard) phase is geometrically in the form of bricks and the organic (soft) phase is geometrically in the form of a mortar between the bricks gives it a toughness three orders of magnitude higher than that of the individual constituent materials. See Song F, Soh A K, Bai Y L, Structural and mechanical properties of the organic matrix layers of nacre, Biomaterials (2003), September 24 (20): 3623-31; doi: 10.1016/s0142-9612 (03) 00215-1. PMID: 12809793.

However, the environmental, cost, access to raw materials and recycling constraints can limit the use of certain materials and therefore also limit the possibilities for making certain composite materials.

These same constraints encourage us to use raw materials as sparingly as possible in the manufacture of structural materials. Finally, a widely explored way of reducing the energy and carbon impact, particularly of vehicles, is to reduce as far as possible the density p (or specific gravity) of the materials used without affecting their mechanical behaviour.

The most natural way to lighten a material is to introduce pores.

Pores can be introduced into the material at random. Examples comprise solid foams and aerogels.

Alternatively, pores can be introduced into the material in a controlled manner.

In particular, this control can be achieved by means of an additive producing. Additive manufacturing allows us to modulate the architecture of the material in extenso, and therefore to arrange the pores in space in a controlled way, and thus control their impact on the mechanical performance.

For example, see the article by T. X. Zheng & al.: Ultrastiff Mechanical Metamaterials, Science, 3434 (6105890), 9621373-965 1377 (20112014) which proposes a micro-lattice architecture composed of periodically arranged micro-beams. As can be seen in this article (FIG. 3A), an “octet-truss” arrangement results in a very high ratio of stiffness to density, whereas a “Kelvin foam” arrangement results in a much lower ratio.

The rules for controlling this stiffness-density ratio in a micro-lattice made of periodically arranged micro-beams are well known.

To do this, we need to control the connectivity Z, i.e. the number of micro-beams per node. Thus, in two dimensions (2D), if the connectivity Z is strictly less than 4, the stiffness varies with the cube of the density and if the connectivity Z is greater than or equal to 6, the stiffness is roughly proportional to the density.

Similarly, in three-dimensional (3D), if the connectivity Z is strictly less than 6, the stiffness varies with the square of the density and if the connectivity Z is greater than or equal to 12, the stiffness is roughly proportional to the density. Thus, for a three-dimensional micro-lattice with a connectivity of Z=12 (the best-known example is the micro-lattice known in the literature as an “octet-truss”), the stiffness of the architecture with a relative density of 1% (with reference to the solid material) is reduced by a factor varying between 300 and 1000 compared with that of the material of which it is made. And for a three-dimensional micro-lattice with a connectivity of Z=4 (the best-known example is the micro-lattice known in the literature as the “Kelvin-foam”), the stiffness of the relative density architecture 1% the stiffness is decreased by a factor of 300000. This information can be found in the article by V. S. Despandes & al.: Foam topology: bending versus stretching dominated architectures, Acta Materialia, 49 (6), 1035-1040 (2001) and V. S. Despandes & al.: Effective properties of the octet-truss lattice material, Journal of the Mechanics and Physics of Solids, 49, 1747-1769.

However, the periodicity has a major disadvantage in that the mechanical behaviour of the resulting micro-lattice is anisotropic. The material is less rigid or more brittle when stressed in certain directions. Because of this anisotropy, it is no longer possible to define the material solely by the usual constants (Young's modulus, Poisson's modulus, yield strength and toughness) used to dimension the structures.

One aim of the invention is to offer a two- or three-dimensional part with an ultra-light composite architecture and adjustable mechanical properties.

In particular, one aim of the invention is to offer such a part with mechanical properties that can be modulated locally over a wide range of values so as to be able, at the very least, to reproduce the reinforcement mechanisms, the combination of functional properties and/or the gradients of properties sought in known composite materials.

Another aim of the invention is to offer such a part without using different individual constituent materials.

To this end, the invention proposes a method for manufacturing a two- or three-dimensional part having a composite architecture with at least two different micro-lattices connected to one another, comprising the following steps:
performing a computer-implemented design step comprising the following steps:
A) defining a domain representing the two- or three-dimensional part to be manufactured, then defining a first sub-domain intended to delimit a first micro-lattice and at least one second sub-domain, complementary to the first sub-domain, intended to delimit a second micro-lattice different from the first micro-lattice;
B) defining, over the whole domain, the coordinates of the generating centres for the first micro-lattice and the second micro-lattice, as follows:
B1) from a random two- or three-dimensional arrangement of non-deformable beads of given diameters throughout said domain, producing a random compact stack of said beads within said domain,
B2) for each bead in the two- or three-dimensional random compact stack in said domain, determining the coordinates of the centre of the bead, then
B3) for each bead in the two- or three-dimensional random compact stack of said domain, associating the coordinates of the centre of the bead with those of a generating centre for any one of the first or second micro-lattice,
C) defining the first micro-lattice bounded by the first sub-domain as follows:
C1) producing a Delaunay triangulation with the generating centres and then associating two nodes connected by a side of a triangle to a micro-beam,
C2) deleting each micro-beam where neither node belongs to the first sub-domain,
C3) identifying and deleting each micro-beam of which only one of the two nodes belongs to the first sub-domain, the node belonging to the first sub-domain then being identified as the boundary node of the first sub-domain,
D) from the co-ordinates of the generating centres obtained at the end of step B3), defining the second micro-lattice different from the first micro-lattice and delimited by the second sub-domain, as follows:
D1) generating a Voronoï diagram using the generating centres as seeds for the diagram, then associating two nodes connected by the Voronoï diagram with a micro-beam,
D2) deleting each micro-beam for which neither of the two nodes belongs to the second sub-domain,
D3) identifying and deleting each micro-beam of which only one of the two nodes belongs to the second sub-domain, the node belonging to the second sub-domain being identified as the boundary node of the second sub-domain;
E) connecting the second micro-lattice to the first micro-lattice.
   the design step also defining a shape and associated transverse dimensions for each micro-beam, and then:
manufacturing the architecture designed in this way.

The method according to the invention may comprise at least one of the following additional steps, taken alone or in combination:
step B1) is carried out using a random arrangement of beads of identical diameters;
step B1) is implemented by a Lubachevsky-Stillinger algorithm, a so-called force bias algorithm, an algorithm derived therefrom, or any succession of these different algorithms;
step E) comprises the following steps: E1) for each identified then deleted micro-beam obtained in step C3), redefining the boundary node of the first sub-domain at the point where the identified then deleted micro-beam intersects the boundary of the first sub-domain, then defining a new micro-beam between the old boundary node and the boundary node thus redefined; E2) for each boundary node of the second sub-domain, searching for the nearest boundary node of the first sub-domain and connecting these two nodes by a micro-beam; E3) for each boundary node of the first sub-domain which has not been connected at the end of step E2), searching for the boundary node of the second sub-domain which is closest to it and connecting these two nodes by a micro-beam;
after step E1), an additional step consisting of connecting each boundary node of the first sub-domain with the nearest boundary node of the first sub-domain;
step E) comprises the following steps: E′1) for each resulting micro-beam identified and then deleted in step D3), redefining the boundary node of the second sub-domain at the point of intersection of the identified and then deleted micro-beam with the boundary of the second sub-domain, then defining a new micro-beam between the old boundary node and the redefined boundary node; E′2) for each boundary node of the first sub-domain, searching for the nearest boundary node of the second sub-domain and connecting these two nodes by a micro-beam; E′3) for each boundary node of the second sub-domain which has not been connected at the end of step E′2), searching for the nearest boundary node of the first sub-domain and connecting these two nodes by a micro-beam;
the method comprises a step, implemented at the end of the design step and consisting of making a lattice of each micro-lattice before implementing the manufacturing step;
the manufacturing step is carried out using additive manufacturing.

The invention also concerns a two- or three-dimensional part having a composite architecture with at least two different micro-lattices connected to each other, the first micro-lattices, isotropic, having an architecture made with micro-beams connected to each other forming Delaunay triangles and the second micro-lattice, also isotropic, having an architecture made with micro-beams connected to each other forming Voronoï cells, each boundary node of the second sub-domain being connected to a boundary node of the first sub-domain and vice versa.

### BRIEF DESCRIPTION OF THE FIGURES

Further objects and characteristics of the invention will become clearer in the following description, made with reference to the attached figures, in which:

FIG. 1 is a schematic representation of the main steps of a method according to the invention for the manufacture of a two- or three-dimensional part having a composite architecture with at least two different micro-lattices connected to each other;

FIG. 2 represents a domain separated into two sub-domains obtained after implementation of a first step of the method according to the invention;

FIG. 3 represents a compact random stack of non-deformable beads of virtually identical diameters, obtained after a subsequent step in the method according to the invention has been carried out by computer;

FIG. 4 represents a cloud of nodes obtained after carrying out by computer a step of the method according to the invention carried out on the basis of the arrangement in FIG. 3;

FIG. 5 represents the micro-lattice obtained in the whole domain after another step in the method according to the invention has been carried out by computer using the cloud of nodes in FIG. 4;

FIG. 6 represents the micro-lattice obtained after carrying out another step of the method according to the invention by computer, based on the micro-lattice of FIG. 5;

FIG. 7 represents the micro-lattice obtained after computer implementation of another step in the method according to the invention, within the second sub-domain;

FIG. 8 is an enlarged view of FIG. 7 in a border zone between the two sub-domains shown in FIG. 2;

FIG. 9 represents the micro-lattice obtained for the first sub-domain after computer implementation of another step in the method according to the invention, which can be carried out using the micro-lattice of FIG. 6;

FIG. 10 represents the micro-lattice finally obtained within the whole domain shown in FIG. 2 after implementing by computer an additional step of the method according to the invention carried out on the basis of the micro-lattice of FIG. 8;

FIG. 11 is an enlarged view of FIG. 10 in a border zone between the two sub-domains shown in FIG. 2;

FIG. 12 shows in two dimensions the Young's modulus (E) of the composite architecture as a whole as a function (on the abscissa) of the density of the material, for several values of the relative proportion of “soft zones” (Voronoï) to “hard zones” (Delaunay).

FIG. 13 shows in two dimensions the modularity of the ratio (G/K) between the shear modulus (G) and the compression modulus (K) of the composite architecture as a whole as a function (in abscissa) of the density of the material, for several values of the relative proportion of “soft zones” (Voronoï) to “hard zones” (Delaunay).

### DETAILED DESCRIPTION OF THE INVENTION

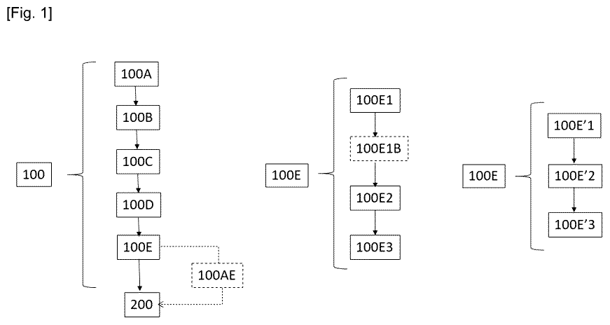

FIG. 1 is a schematic representation of the various main steps of the method according to the invention.

The invention relates to a method of manufacturing a two- or three-dimensional part having a composite architecture with at least two different micro-lattices connected to each other, comprising the following steps:
performing 100 a computer-implemented design step; then
manufacturing 200 the architecture designed in this way.

The computer-implemented design step comprises the following steps A) to E).

Step A) consists in defining 100A a domain representing the two- or three-dimensional part to be manufactured, then defining a first sub-domain intended to delimit a first micro-lattice and at least one second sub-domain, complementary to the first sub-domain, intended to delimit a second micro-lattice different from the first micro-lattice.

B) defining (100B), over the whole domain, the coordinates of generating centres for the first micro-lattice and the second micro-lattice, as follows:

Step B) consists in defining, over the whole domain, the coordinates of the generating centres for the first micro-lattice and the second micro-lattice as follows:

B1) starting from a random two- or three-dimensional arrangement 100BINIT of non-deformable beads of given diameters throughout said domain, producing 100B1 a random compact stack of said beads within said domain,

B2) for each bead in the two- or three-dimensional random compact stack in said domain, determining 100B2 the coordinates of the centre of the bead, then

B3) for each bead of the two- or three-dimensional random compact stack of said domain, associating 100B3 the coordinates of the centre of the bead with those of a generating centre for any one of the first or second micro-lattice,

Step C) consists of defining the first micro lattice delimited by the first sub-domain as follows: C1) making 100C1 a Delaunay triangulation with the generating centres (in this case nodes) and then associating two nodes connected by a triangle side to a micro-beam,

C2) deleting 100C2 each micro-beam where neither node belongs to the first sub-domain,

C3) identifying and deleting 100C3 each micro-beam of which only one of the two nodes belongs to the first sub-domain, the node belonging to the first sub-domain then being identified as the boundary node of the first sub-domain.

Then, step D) consists, on the basis of the coordinates of the generating centres obtained at the end of step B3), in defining 100D a second micro-lattice different from the first micro-lattice and delimited by the second sub-domain, as follows:

D1) generating 100D1 a Voronoï diagram using said generating centres as seeds of said diagram and then associating two nodes connected by the Voronoï diagram with a micro-beam,

D2) deleting 100D2 each micro-beam where neither node belongs to the second sub-domain, D3) identifying and deleting 100D3 each micro-beam of which only one of the two nodes belongs to the second sub-domain, the node belonging to the second sub-domain being identified as the boundary node of the second sub-domain.

Step E) consists of connecting 100E the second micro-lattice to the first micro-lattice. From a practical point of view, there are various ways of connecting the second micro-lattice to the first micro-lattice, which will be explained in more detail later.

The design step also involves defining a shape and associated transverse dimensions for each micro-beam.

We will explain this method with the help of an example of embodiment. For the sake of clarity of representation, we have chosen to do this in 2 dimensions, but extrapolation into 3 dimensions is straightforward.

### Step A)

Step 100A consists of defining a domain representing the two- or three-dimensional part to be manufactured, then defining a first sub-domain intended to delimit a first micro-lattice and a second sub-domain, complementary to the first sub-domain, intended to delimit a second micro-lattice different from the first micro-lattice.

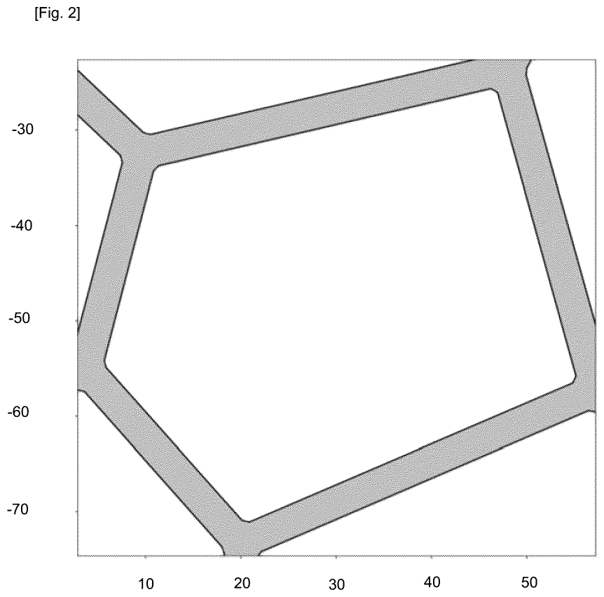

An example of a domain separated into a first sub-domain (in white) and a second sub-domain (in grey) is shown in FIG. 2.

### Step B)

We start 100BINIT with a three-dimensional random arrangement of non-deformable beads. The term beads covers either a ball (solid) or a sphere (hollow) in the mathematical sense of the term.

These beads each have a given diameter. It is important to be able to fix these diameters as they determine the length of the micro-beams in the method described in the invention. The diameter of the different beads is not necessarily identical.

However, it is advantageous to start from an arrangement with beads having close diameters, typically with a variation of no more than 30% in relation to a mean value, or identical to minimise the standard deviation from the mean length of the micro-beams present in the micro-lattice that we are seeking to manufacture. The homogeneity of the length of the micro-beams, together with the random nature of the distribution of the beads within the compact three-dimensional stack of beads, helps to define an isotropic architecture.

From this initial state, the aim of the step is to obtain 100B1 a random compact stack of said beads within the whole domain.

There are various types of algorithm in the literature for obtaining this type of stack. For example, a Lubachevsky-Stillinger algorithm, a force-biased algorithm, an algorithm derived from these, or any combination of these algorithms can be used.

The Lubachevsky-Stillinger algorithm is widely known and has been the subject of numerous publications. For further information, see the article by Lubachevsky, Boris D.; Stillinger, Frank H. 1990: Geometric properties of random disk packings, Journal of Statistical Physics, 60 (5-6): 561-583.

The force-biased algorithm is also widely known and has been the subject of numerous publications. However, reference may be made to J. Mościński, M. Bargiel, Z. A. Rycerz & P. W. M. Jacobs (1989) The Force-Biased Algorithm for the Irregular Close Packing of Equal Hard Spheres, Molecular Simulation, 3:4, 201-212.

In this case, the procedure used in the example under consideration to generate the random arrangement of beads within said domain and thus implement step 100B1 is as follows.

We used the algorithm developed by Vasili Baranau, available at https://github.com/VasiliBaranov/packing-generation (distributed under MIT licence). The user must specify as input: 1) the size of the container containing the stack, 2) the diameters of the beads, 3) the number of iterations of the algorithm, 4) the contraction rate, 5) an integer used as a seed for the pseudo-random number generator.

The container, which is circular (we are in 2D), has been chosen with a radius of size 100 (an arbitrary dimension). This is the size of the container before the beads are compacted. The beads were chosen with almost identical diameters, with a log normal distribution with a mean value set at 1 (arbitrary dimension) and a standard deviation of 0.2. A total of 8800 beads were considered.

100 iterations were performed.

The contraction rate was chosen to be 0.1 (arbitrary unit). The lower the rate of contraction, the more compact the stack of beads will be.

The integer used as the seed for the pseudo-random number generator was chosen at random.

The algorithm uses this seed to generate the initial positions of the beads in the container.

The algorithm (called PackingGeneration.exe) is then run in “fba” mode (this is a “Forced-Biased” algorithm). The pre-stack obtained after running this algorithm is given in a packing.xyzd file containing the X, Y positions and D diameters of each bead. This packing.xyzd file is backed up by another packing.nfo file containing various parameters characteristics of the pre-stack (e.g. compactness).

We then use these last two files as inputs to the same algorithm (PackingGeneration.exe) but run in “Is” mode (indicating a Lubachevsky-Stillinger algorithm). We then obtain a new packing.xyzd file containing the positions X, Y, Z and the diameters D updated after compaction and also a new packing.nfo file comprising information on the pre-stacking thus obtained.

We use these new packing.xyzd and packing.nfo files as inputs to the same algorithm (PackingGeneration.exe) but now in “Isgd” mode (an algorithm derived from the Lubachevsky-Stillinger algorithm, with an option known as gradual densification). At this stage, the packing.xyzd file contains the positions and diameters of the beads in the three-dimensional random compact stack and the file contains various information about the stack and, in particular, its compactness. The compactness obtained in this example is 0.88.

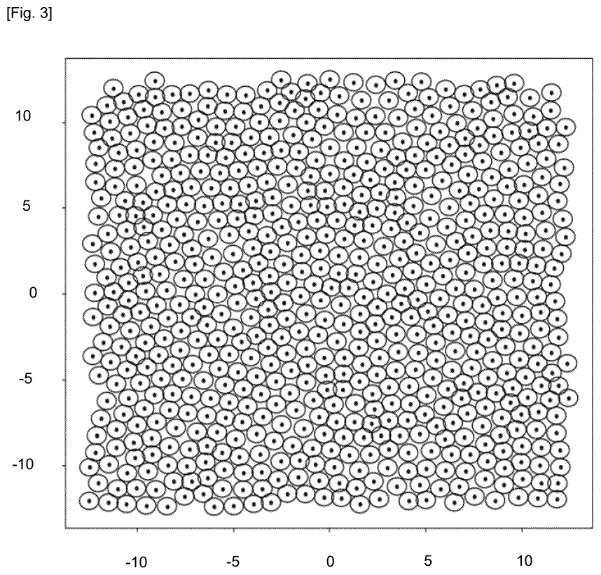

Finally, the coordinates X, Y of the centre of each bead were modified in the packing.xyzd file, by dividing the values mentioned by a rescaling factor F defined as follows:

$$F = {( \frac{1 - {p}_{f i n}}{1 - {p}_{th}} )}^{1 / 3} \qquad [ Maths 1 ]$$

where the parameters p_{fin} and pₜₕ are both given in packing.info. In this case, the scaling factor F is F=1.0842. The implementation of this correction is linked to the implementation of the computer program chosen to illustrate the method according to the invention, but there is nothing systematic about implementing step 101 of the method according to the invention. FIG. 3 shows the compact random stack of non-deformable beads of virtually identical diameters (the variability of the diameters does not exceed 20% with respect to an average diameter), obtained after carrying out step 100B1 of the method according to the invention by computer. The 2D geometry of the stack requires a statistical distribution of diameters to avoid crystallisation. Here the distribution is log normal, with a mean value set at 1 and a standard deviation of 0.2.

Next, step 100B2 consists, for each bead in the two- or three-dimensional random compact stack of said domain, in determining 100B2 the coordinates of the centre of each bead.

In this case, the coordinates of the centre of each bead are available in the packing.xyzd file obtained at the end of step 100B1.

Then, step 100B3 consists, for each bead in the two- or three-dimensional random compact stack of the domain, in associating the coordinates of the centre of the bead with those of a generating centre for any one of the first or second micro-lattice.

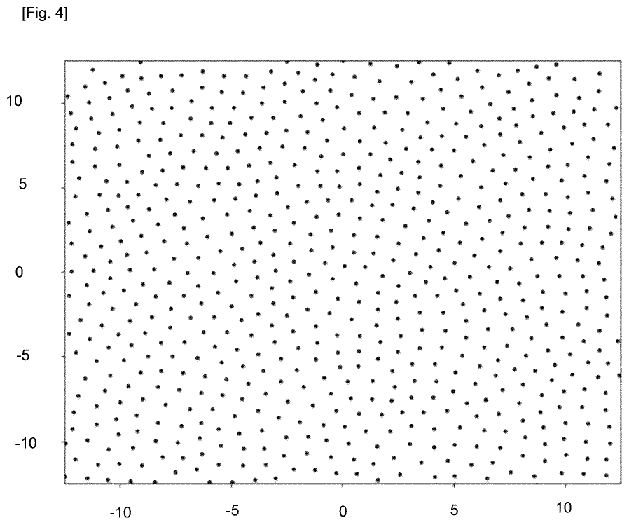

FIG. 4 shows the cloud of generating centres obtained after computer implementation of step 100B3.

### Step C)

The aim of step 100C is to define a first micro-lattice bounded by the first sub-domain.

In step 100C1, a Delaunay triangulation is performed with the generating centres obtained at the end of step B3).

This triangulation defines the triangles with the closest nodes, which allows to maintain a certain homogeneity in the length of the sides of each triangle. This homogeneity is important because, as we will see later in the description, it defines the homogeneity of the length of the micro-beams. However, defining micro-beams with homogeneous lengths (low dispersion) within the micro-lattice to be manufactured is important for obtaining good mechanical properties, particularly with regard to stiffness (E/p ratio). A Delaunay triangulation was implemented in the following example of embodiment. To be more precise, please refer to the following document which gives the algorithm: https://docs.scipy.org/doc/scipy/reference/generated/scipy.spatial.Delaunay.html (Python). This is what is used in the example of embodiment described here.

Then, to define the micro-lattice, all you have to do is associate two nodes connected by a side of triangle to a micro-beam in a dedicated file.

The length of a micro-beam is then entirely determined by the distance between two nodes belonging to the same triangle. The distance separating two nodes belonging to the same triangle is itself defined by the selected diameter of the beads prior to the implementation of the method according to the invention and the step 100B1 of producing the random compact stack within said domain.

The shape of the micro-beams and the associated transverse dimensions are data supplied independently.

The shape and transverse dimensions of the micro-beams can be defined at various points during the design step 100. This data is only useful for the actual manufacturing method. In particular, once the shape has been fixed, determining the transverse dimensions enables the final relative density of the micro-lattice to be set. These transverse dimensions may differ from one micro-beam to another. However, the choice of an identical cross-sectional shape with the same transverse dimensions for all the micro-beams allows to control easily the relative density of the architecture we are seeking to build. So, for example in two-dimensional (2D), if these transverse dimensions are significantly smaller than the length of the micro-beams (a situation allowing a low relative density), the relative density of the architecture to be manufactured evolves as the ratio between this transverse dimension and the average length of the micro-beams.

In practice, in 2D, a plate-shaped micro-beam can be provided. In 3D, for example, the shape could be cylindrical.

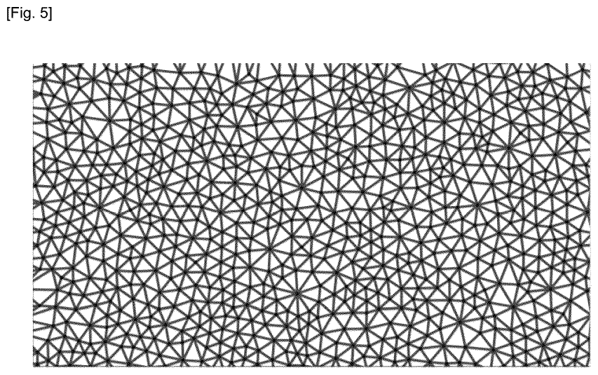

FIG. 5 shows the micro-lattice obtained at the end of step 100C1.

A step 100C2 is then carried out, which consists of deleting each micro-beam where neither of the two nodes belongs to the first sub-domain.

A step 100C3 is then carried out, which consists of identifying and deleting each micro-beam where only one of the two nodes belongs to the first sub-domain. The node belonging to the first sub-domain is then identified as the boundary node of the first sub-domain.

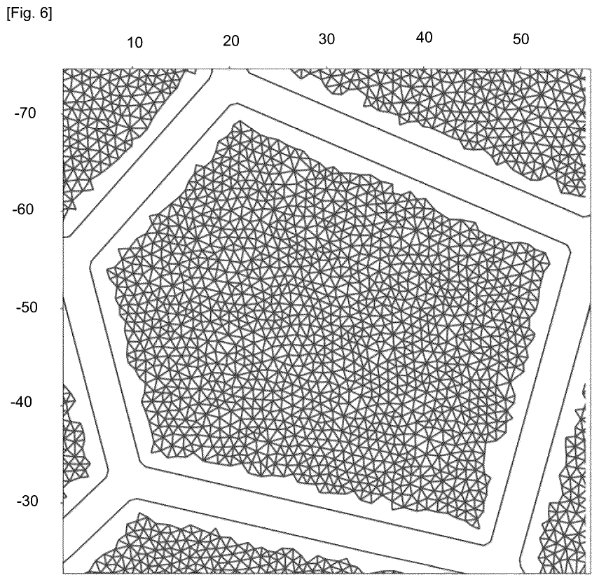

FIG. 6 shows the micro-lattice obtained at the end of step 100C3.

Step C) thus generates within the first sub-domain a micro-lattice with a globally amorphous, isotropic architecture and a maximum E/p ratio. The construction of this micro-lattice is based on Delaunay triangulation, applied to a random compact stack of beads, advantageously monodispersed. This triangulation guarantees, for a given domain of size consistent with those of a triangle (i.e. a domain of size much larger than those of triangles), that the connectivity at any node is at least equal to 6 in two dimensions (2D), or at least equal to 12 in three dimensions (3D) and the global isotropy is inherited from the globally amorphous construction of the bead stack. This micro-lattice therefore has a substantially well-defined Young's modulus and Poisson's modulus, and high stiffness. The stiffness then varies substantially linearly with density in both 2D and 3D.

### Step D)

The aim of the step 100D is to define the second micro-lattice, different from the first micro-lattice, and delimited by the second sub-domain. The second sub-domain complements the first sub-domain within the domain.

Here, on the basis of the coordinates of the generating centres obtained at the end of step B3), the step 100D1 consists in generating a Voronoï diagram using the generating centres as seeds of said diagram and then, said diagram connecting two nodes of the Voronoï diagram by a micro-beam. In other words, each of the edges of the polygons (in two dimensions) or polyhedra (in three dimensions) defined by the Voronoï diagram is associated with a micro-beam, and each of the vertices of these polygons or polyhedra with a node.

Then, in step 100D2, each micro-beam whose two nodes do not belong to the second sub-domain is deleted.

Then, it is finally necessary to identify and delete 100D3 each micro-beam whose only one of the two nodes belongs to the second subdomain, the node belonging to the subdomain being identified as boundary node of the second subdomain.

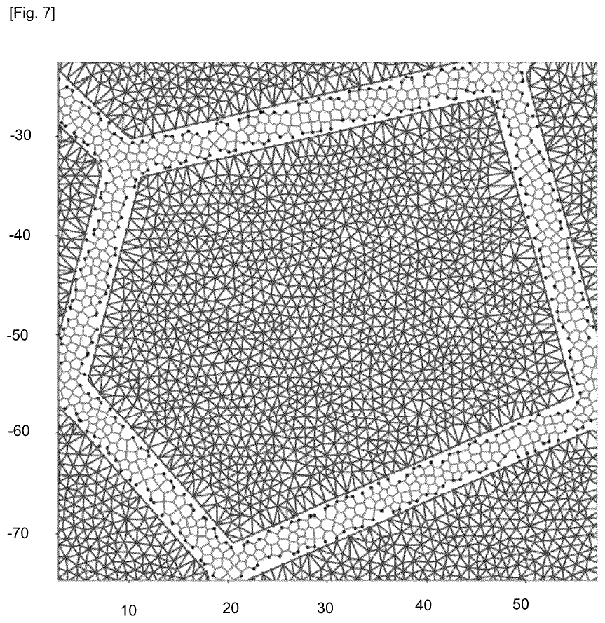

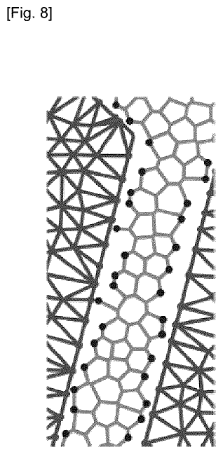

The result of the Voronoï tessellation carried out in the second sub-domain can be seen in FIGS. 7 and 8. FIG. 8 is an enlarged view of FIG. 7, at a border zone between the two sub-domains. The boundary nodes are identified by circles.

Step D) thus generates a micro-lattice for the second sub-domain with a generally amorphous, isotropic architecture and a minimum E/p ratio. The construction of this micro-lattice is based on a Voronoï tessellation applied to a random compact stack of beads, advantageously monodispersed. The Voronoï tessellation ensures that the connectivity at any node is equal to 3 in two dimensions (2D), or equal to 4 in three dimensions (3D), and the global isotropy is then inherited from the globally amorphous construction of the bead stack. This micro-lattice therefore has a substantially well-defined Young's modulus and Poisson's modulus, and low stiffness. The Young's modulus varies approximately as the cube of the density in 2D, or as the square of the density in 3D.

### Step E)

Step 100E consists of connecting the second micro-lattice (obtained at the end of step D) to the first micro-lattice (obtained at the end of step C).

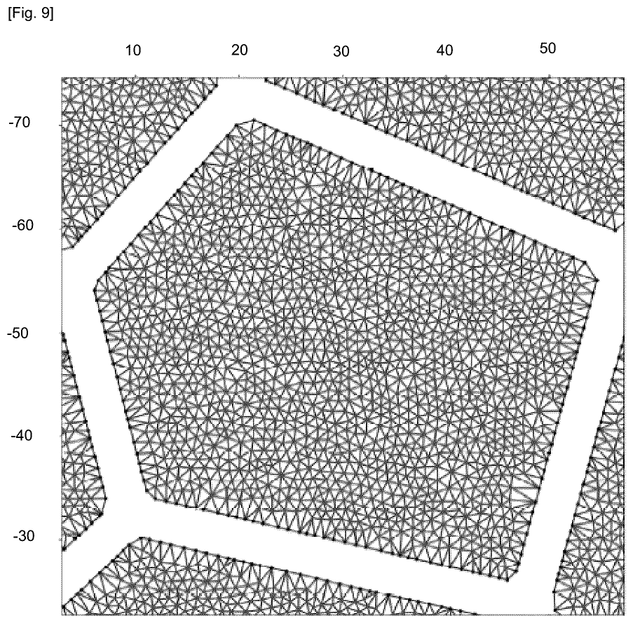

FIG. 9 gives a better idea of what has been done on the first sub-domain since the configuration in FIG. 7 to match the Delaunay triangulation with the boundaries of the first sub-domain.

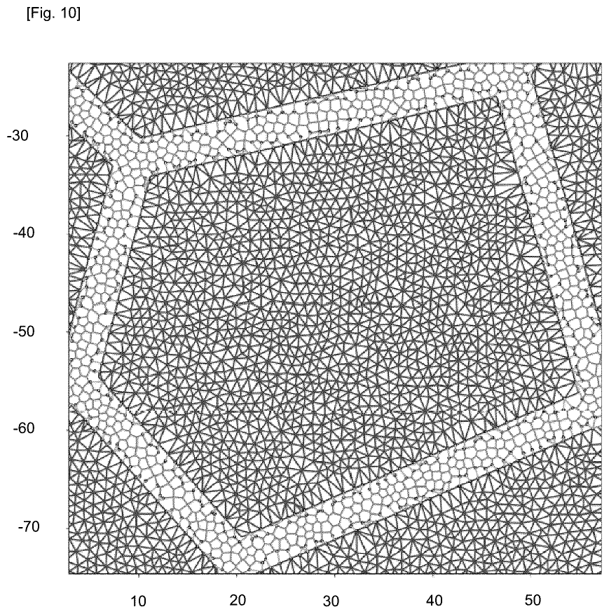

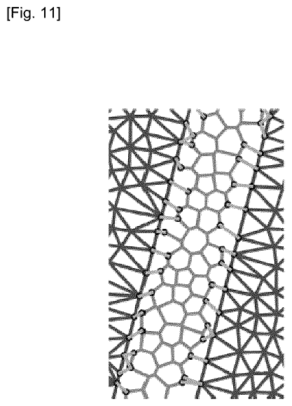

FIGS. 10 and 11 show the connection between the two sub-domains in more detail.

In step C3), each micro-beam for which only one of the two nodes belonged to the first sub-domain was identified and then deleted.

Thus, initially, for each micro-beam thus identified and then deleted at the end of step C3), the boundary node of the first sub-domain can be redefined 100E1 at the point where the micro-beam identified and then deleted intersects with the boundary of the first sub-domain, then a new micro-beam can be defined between the old boundary node and the boundary node thus redefined.

After step 100E1, an optional step 100E1B is also provided, during which each boundary node of the first sub-domain is connected to the nearest boundary node of the first sub-domain. This increases the connectivity of nodes on the border of the first sub-domain. This step 100E1B may be carried out immediately after step 100E1, but may also be carried out later during step 100E.

FIG. 9 shows the micro-lattice obtained at the end of step 100E1B.

For each boundary node of the second sub-domain identified in step 100D3, the nearest boundary node of the first sub-domain is searched for in step 100E2 and these two nodes are connected by a micro-beam.

Then, for each boundary node of the first sub-domain which has not been connected at the end of step 100E2, it is necessary to search, in step 100E3, for the boundary node of the second sub-domain which is closest to it and to connect these two nodes by a micro-beam. This ensures that each boundary node in one sub-domain is connected to a boundary node in the other sub-domain.

FIG. 10 shows the result of step E) as described above. FIG. 11 is an enlarged view of FIG. 10 at a border zone between the two sub-domains.

The design is now complete.

All that is then needed is to carry out manufacturing step 200.

However, depending on the manufacturing method used, it may be necessary to implement an additional step 100AE during the design step 100, which consists of producing a lattice representative of the micro-lattice obtained at the end of step 100E. This lattice is typically produced using computer-aided design (CAD) software. This is the case, for example, if step 200 of the manufacturing method is performed using additive manufacturing. Step 100AE can also be used to define a shape and associated transverse dimensions for each micro-beam, for example a plate shape for a two-dimensional (2D) micro-lattice, or a cylinder shape with its diameter defined for a three-dimensional (3D) micro-lattice.

Other connection strategies between the two sub-domains are also possible.

For example, you can proceed as follows.

In step D3), each micro-beam for which only one of the two nodes belonged to the second sub-domain was identified and then deleted.

Thus, initially, for each micro-beam thus identified and then deleted at the end of step D3), it is possible to redefine 100E′1 the boundary node of the second sub-domain at the point of intersection of the micro-beam identified and then deleted with the boundary of the second sub-domain, and then define a new micro-beam between the old boundary node and the boundary node thus redefined.

For each boundary node of the first sub-domain identified in step 100C3, the nearest boundary node of the second sub-domain is sought in step 100E′2 and these two nodes are connected by a micro-beam.

Then, for each boundary node of the second sub-domain which has not been connected at the end of step 100E′2, the nearest boundary node of the first sub-domain is sought in step 100E′3 and these two nodes are connected by a micro-beam.

An additional (optional) step may be provided, for example after step 100E′1, to increase the connectivity of the nodes at the border of the two sub-domains, in order to achieve a smoother transition with the other sub-domain.

It should also be noted that the order of the steps, from step A) to step E) in alphabetical order in the above example, can be adapted. Steps C) and D) can therefore be reversed.

Finally, it should be noted that although in the above example the first sub-domain in which Delaunay triangulation is performed is the larger of the two sub-domains (see figures), this is merely a choice for the purposes of illustration. So, depending on the desired result, the first sub-domain in which the Delaunay triangulation is performed could very well be the smaller of the two sub-domains.

Within the framework of the invention, it is possible to manufacture a composite architecture composed of hard zones (Delaunay triangulation) and soft zones (Voronoï tessellation) on a domain that can have any geometry, whether in two or three dimensions. The density of each of these micro-lattices can be modulated over a wide range, as can their elastic modulus and the ratio of shear response to compression response. The ranges available cover several orders of magnitude.

By judiciously assembling hard and soft zones, it is also possible to reproduce the various mechanisms used in traditional composites, without using different constituent materials for these zones: reinforcement mechanisms, gradients in functional properties, combinations of properties that are a priori exclusive (the brick-and-mortar structure of mother-of-pearl, for example, giving it hardness and toughness).

Furthermore, within the framework of the present invention, for each micro-lattice of the composite architecture, an amorphous architecture is generated without starting from a periodic network, and which therefore exhibits a lack of order at medium and long range. Within each micro-lattice, the mechanical behaviour is therefore globally isotropic. In addition, the mechanical performances obtained are optimal (for example, maximum E/p ratio in the hard zones and minimum E/p ratio in the soft zones).

Finally, depending on the prescribed distribution of hard and soft zones, the local mechanical behaviour in the total micro-lattice can be modulated.

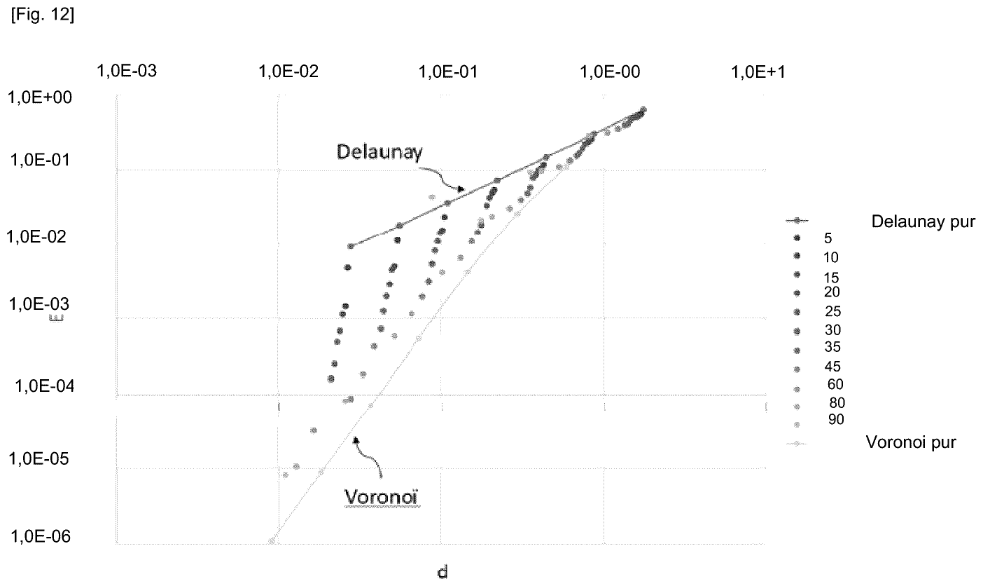

FIG. 12 shows, for example, the modularity of the Young's modulus (E) of the composite architecture as a whole as a function (in abscissa) of the density (d) of the material, for several values of the relative proportion of “soft zones” (Voronoï) to “hard zones” (Delaunay). In particular, the figure shows a straight line representing the Young's modulus as a function of density in pure Voronoï, as well as another line representing the same evolution but in pure Delaunay. Between these two lines, we can see that by varying the density of the material and the proportion of the different soft and hard zones, it is possible to pave a wide range of Young's modulus values.

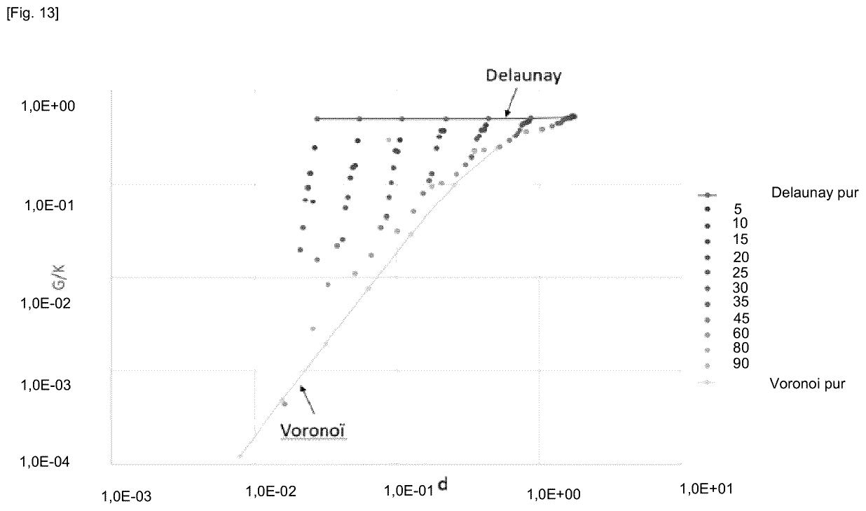

FIG. 13 shows the modularity of the ratio (G/K) between the shear modulus (G) and the compression modulus (K) of the composite architecture as a whole as a function (on the abscissa) of the density (d) of the material, for several values of the relative proportion of “soft zones” to “hard zones”. In particular, the figure shows a straight line representing the evolution of the G/K ratio as a function of density in pure Voronoï, as well as another straight line representing the same evolution but in pure Delaunay. Between these two lines, we can see that by varying the density of the material and the proportion of the different zones, it is possible to obtain a modular material that is resistant to compression deformation or shear deformation. It is also possible to subdivide the domain in step A) into more than two sub-domains to define as many different micro-lattices as possible. For example, the domain can be subdivided into N sub-domains, with N a natural number greater than or equal to 3, in which the various sub-domains are complementary to each other within the domain.

The method simply needs to be adapted with additional steps. For example, if we consider N=3 sub-domains in step A), we continue with steps B) and C) and then add a step C′) on another sub-domain similar to step C) before continuing with step D) for the last sub-domain. The connection between two sub-domains then follows the same rules as in step E). The invention also concerns a two- or three-dimensional part having a composite architecture with at least two different micro-lattices connected to each other, the first micro-lattice, isotropic, having an architecture made with micro-beams connected to each other forming Delaunay triangles and the second micro-lattice, also isotropic, having an architecture made with micro-beams connected to each other forming Voronoï cells, each boundary node of the second sub-domain being connected to a boundary node of the first sub-domain, and vice versa.

This is the part obtained directly by carrying out steps A) to E) described above.

1. A method of manufacturing a two- or three-dimensional part having a composite architecture with at least two different micro-lattices connected to one another, comprising the following steps:
performing (100) a computer-implemented design step comprising the following steps:
A) defining (100A) a domain representing the two- or three-dimensional part to be manufactured, then defining a first sub-domain intended to delimit a first micro-lattice and at least one second sub-domain, complementary to the first sub-domain, intended to delimit a second micro-lattice different from the first micro-lattice;
B) defining (100B), over the whole domain, the coordinates of generating centres for the first micro-lattice and the second micro-lattice, as follows:
B1) from a random two- or three-dimensional arrangement (100BINIT) of non-deformable beads of given diameters throughout said domain, producing (100B1) a random compact stack of said beads within said domain,
B2) for each bead in the two- or three-dimensional random compact stack in said domain, determining (100B2) the coordinates of the centre of the bead, then
B3) for each bead of the two- or three-dimensional random compact stack of said domain, associating (100B3) the coordinates of the centre of the bead with those of a generating centre for any one of the first or second micro-lattice,
C) defining (100C) the first micro-lattice bounded by the first sub-domain as follows:
C1) producing (100C1) a Delaunay triangulation with the generating centres and then associating two nodes connected by a side of a triangle to a micro-beam,
C2) deleting (100C2) each micro-beam where neither of the two nodes belongs to the first sub-domain,
C3) identifying and deleting (100C3) each micro-beam of which only one of the two nodes belongs to the first sub-domain, the node belonging to the first sub-domain then being identified as the boundary node of the first sub-domain,
D) from the coordinates of the generating centres obtained at the end of step B3), defining (100D) the second micro-lattice different from the first micro-lattice and delimited by the second sub-domain, as follows:
D1) generating (100D1) a Voronoï diagram using the generating centres as seeds for said diagram and then associating two nodes connected by the Voronoï diagram with a micro-beam,
D2) deleting (100D2) each micro-beam for which neither of the two nodes belongs to the second sub-domain,
D3) identifying and deleting (100D3) each micro-beam of which only one of the two nodes belongs to the second sub-domain, the node belonging to the second sub-domain being identified as the boundary node of the second sub-domain;
E) connecting (100E) the second micro-lattice to the first micro-lattice.
the design step also defining a shape and associated transverse dimensions for each micro-beam, and then:
manufacturing (200) the architecture designed in this way.

2. The method according to claim 1, wherein step B1) is carried out using a random arrangement of beads of identical diameters.

3. The method according to claim 1, wherein step B1) is implemented by a Lubachevsky-Stillinger algorithm, a so-called force bias algorithm, an algorithm derived therefrom or any succession of these different algorithms.

4. The method according to claim 1, wherein step E) comprises the following steps:
E1) for each identified then deleted micro-beam obtained in step C3), redefining (100E1) the boundary node of the first sub-domain at the point where the identified then deleted micro-beam intersects the boundary of the first sub-domain, then defining a new micro-beam between the old boundary node and the boundary node thus redefined,
E2) for each boundary node of the second sub-domain, searching (100E2) for the nearest boundary node of the first sub-domain and connecting these two nodes by a micro-beam,
E3) for each boundary node of the first sub-domain which has not been connected at the end of step E2), searching (100E3) for the boundary node of the second sub-domain which is closest to it and connecting these two nodes by a micro-beam.

5. A manufacturing method according to claim 1, wherein step E) comprises, after step E1), an additional step (100E1B) consisting of connecting each boundary node of the first sub-domain with the nearest boundary node of the first sub-domain.

6. The method according to claim 1, wherein step E) comprises the following steps:
E′1) for each resulting micro-beam identified and then deleted in step D3), redefining (100E′1) the boundary node of the second sub-domain at the point of intersection of the identified and then deleted micro-beam with the boundary of the second sub-domain, then defining a new micro-beam between the old boundary node and the redefined boundary node,
E′2) for each boundary node of the first sub-domain, searching (100E′2) for the nearest boundary node of the second sub-domain and connecting these two nodes by a micro-beam,
E′3) for each boundary node of the second sub-domain which has not been connected at the end of step E′2), searching (100E′3) for the boundary node of the first sub-domain which is closest to it and connecting these two nodes by a micro-beam.

7. The method according to claim 1, wherein it comprises a step (100AE), implemented at the end of the design step (100) and consisting of making a lattice of each micro-lattice before implementing the manufacturing step.

8. The method according to claim 1, wherein the manufacturing step is carried out by additive manufacturing.

9. A two- or three-dimensional part having a composite architecture with at least two different micro-lattices connected to each other, the first micro-lattice, isotropic, having an architecture made with micro-beams connected to each other forming Delaunay triangles and the second micro-lattice, also isotropic, having an architecture made with micro-beams connected to each other forming Voronoï cells, each boundary node of the second sub-domain being connected to a boundary node of the first sub-domain and vice versa.
